(19) United States
(12) Patent Application Publication
(10) Pub. No.: US 2002/0174064 A1
(43) Pub. Date: Nov. 21, 2002

(54) System and method for internet cash payment

(76) Inventor: Hong Li, San Diego, CA (US)

Correspondence Address: Hong Li, 4431 Shorepointe Wy, San Diego, CA, 92130, US

(21) Appl. No.: 09/860,160

(22) Filed: May 17, 2001

(51) Int. Cl. G06F 17/60

(52) U.S. Cl. 705/39

(57) ABSTRACT

An internet-cash payment system comprises the internet-cash, a telecommunication network, and computers with special software for payers, payees, and issuers of the internet-cash. The internet-cash comprises codes, which are different from each other, and for onetime use only. A bill of the internet-cash to be paid is an icon on a computer screen, and contains its issuer's email address for an online transaction. A payer can use a computer to send the internet-cash by dropping a bill icon to a cash collection icon at a payee's website. The collection icon automatically forwards the internet-cash to its issuer's computer to check in the computer record. If the internet-cash matches the record for the first time, the issuer's computer will automatically deposit the cash to the payee's account, and send a receipt to the payee and the payer. If the internet-cash is rejected, the issuer's computer will send a rejection notice to the payee and the payer. This internet-cash payment system is very convenient for small transactions such as pay-per-view of internet news, internet search engines and other internet websites, since there is no need for a payer to type in any private information such as a credit card number, a home address, a phone number and so on for a transaction.

### FIELD AND BACK GROUND OF THE INVENTION

The present invention relates to a network payment system and method, and in particular, to an internet-cash (Cyber-cash) payment system and method.

Limitations of the prior art for internet payment methods and systems are: 1. Inconvenient. A payer is required to provide information including a pin number, a card number, an address, a signature and so on. 2. Not private, not secure. Consumers are venerable by often giving this information to many businesses. 3. A special device is needed. Devices such as an e-cash purse with an electrical circuit, a bank card or credit card, and a card port are often needed to be used.

These limitations make pay-per-view for internet websites very difficult and not feasible. As a result, revenues of most internet service companies are mainly from online advertising and most of the companies are not successful in generating revenues by online advertising.

The present invention is to address these problems.

### OBJECT AND BRIEF SUMMARY OF THE INVENTION

The object of this invention is to provide an internet-cash payment system that does not require payers to provide any information or require any special device, which makes online payments convenient, private, secure and fast.

According to the present invention, an internet-cash payment system comprises the internet-cash, a telecommunication network, and computers with special software for payers, payees, and issuers of the internet-cash.

The internet-cash comprises codes, which are different from each other, and for onetime use only. It can be saved in a computer and a computer disk, and is transferable among computers through a telecommunication network. A bill of the internet-cash to be paid can appear as an icon on a computer screen, and contains its issuer's email address for an online transaction.

The internet-cash can be bought by payers from its issuer. A payer can use a computer to send the internet-cash by dropping a bill icon to a cash collection icon at a payee's website. The collection icon automatically forwards the internet-cash to its issuer's computer to check in the computer record. If the internet-cash matches the record for the first time, the issuer's computer will automatically deposit the cash to the payee's account, and send a receipt to the payee and the payer. If the internet-cash is rejected, the issuer's computer will send a rejection notice to the payee and the payer.

The whole transaction can be completed in seconds or minutes with low cost, without any special device, and without having to type in any information about a payer such as a credit card number, a home address, a phone number and so on for a transaction.

Such an internet-cash payment system is very convenient, especially for small transactions such as pay-per-view of internet news, internet search engines and other internet websites.

### DESCRIPTION OF PREFERRED EMBODIMENTS

Internet Cash

In the system according to the present invention, each bill of the internet-cash comprises at least one code, made by an issuer's computer, recognizable and manageable by a special software. Each of the codes can be similar to the code stored on the magnetic band of an ATM card or credit card. It can also include numerical numbers and letters. Each code can be one bill of the internet-cash with a fixed value preset by an issuer such as one cent, five cents, one dollar, ten dollars and so on. The codes are different from each other, and are for onetime use only. Many of the one-code bills can be combined by the software into a large bill consisting of multi-codes with a value equivalent of all the one-code bills in it. The internet-cash contains an issuer's online contact information such as an email address and a phone number for online transactions. A user's (payer's) email address can also be put into each code by an issuer to restrict its use.

A bill of the internet-cash to be paid can appear as an icon on a computer screen using a special software. The bill icon, not only can be felt like a coin or paper money, but also can be dragged around on the screen to be dropped in a collection icon in a payee's website for a payment. The bill icon can also be clicked to adjust an amount of the internet-cash to be paid.

The internet-cash can be stored in a computer and a computer disk. The internet-cash is to be used for telecommunication transactions. The internet-cash can be transmitted through the internet, a phone line, a fiber optical line and a wireless communication network.

Internet-Cash Software for Payer

An internet-cash software in a computer can recognize the internet-cash and make it into a cash image. The software can also manage the internet-cash by adjusting an amount of the internet-cash to be paid, showing the balance and a record of transactions, keeping receipts and so on.

The internet-cash software can appear as an icon (main icon) on a computer screen. When the main icon is right clicked and released, a new icon (the internet-cash icon) will appear to be used for a payment. The internet-cash icon can be turned off by right clicking it, or by dragging it into the main icon.

There is a box in the internet-cash icon to show the amount of the internet-cash to be paid, which can be typed in, or adjusted by the UP and the DOWN arrows on the cash icon. When there are enough small bills such as pennies, an amount of the payment can be adjusted continuously. However, if there are not enough small bills to pay an exact amount, an error message will appear to tell the situation together with the nearest possible amount right above and blow the exact amount.

A cash management window of the internet-cash will appear by double left clicking the cash icon, in which available bills with different sizes and issuers as well as the total amount of the internet-cash available will be shown. In the cash management window, different sizes and issuers of bills as well as total cash value can be selected for a payment. The quantity of the cash icons to be appeared on a computer screen can also be selected, which is useful in some cases when many bills are to be spent one after another like in the case of an online slot machine.

A file window of a balance and a record of transactions will appear by double left clicking the main icon or from the computer file manual. The remaining cash excludes the amount in the box of the internet-cash icon. In the file window there are functional buttons for different sections like: VIEW, BALANCE, TRANSACTION HISTORY, and BILL SELECTION. Each of these sections can be opened by double left clicking its button.

In the VIEW section, there are ON and OFF buttons to show and hide the balance. By pushing the ON button, the remaining cash amount will be shown in the main icon (or disappeared from the main icon by pushing the OFF button). The balance amount on the main icon will change simultaneously according to the amount put into the internet-cash icon to be paid.

In the BALANCE section, a total balance as well as a detailed balance will be shown. The detailed balance information includes the amount of different size bills including pennies, nickels, dimes, dollar, ten dollar, twenty dollar and one hundred dollar, and the amount of the internet-cash from different issuers.

In the TRANSACTION HISTORY section, there are two buttons: RECORD and RECEIPT. In the RECORD section, information on payments and purchases of the internet-cash will be recorded such as the date, time, quantity, payee and issuer. In the RECEIPT section, receipts will be stored with information of payees and issuers, dates, and time. Receipts and records can be deleted when needed.

In the BILL SELECTION section, preferred bills for a payment can be preset. A specific bill selection method can be set as a default condition to automatically control the bill selection procedure unless bills are manually selected on the cash management window mentioned above during the time of payment. A spreadsheet will show up after BILL SELECTION button is pushed. Different sizes of bills can be set to be picked up in certain order, such as picking up the largest bill first within the total payment amount. Bills from different issuers can also be set to be picked up in order. The sequence between size and issuer can also be set.

Internet-Cash Software for Payee and Issuer

Payees and issuers use an internet-cash software similar to that used by payers, except that a payee's software can receive a payment, an issuer's software can issue and receive the internet-cash, both can send receipts and rejection notices to payers, and that these functions can be done automatically.

A payee's software can receive a payment by putting a collection icon on its website. It can automatically forward the internet-cash received from a payer to its issuer's computer for confirmation and deposition. It can also automatically forward receipts and rejection notices to a payer from an issuer regarding payments. A payee's computer can also send its own receipts and notices to a payer. All transactions and receipts will be recorded.

An issuer's software can issue bills of the internet-cash with different codes and bill values. It can also receive, confirm or reject, and deposit the internet-cash. All the transactions, issued bills and deposited bills will be recorded.

When a bill matches for the first time its record in the issuer's computer, the bill will be accepted and deposited in the payee's account. The payee's account can be automatically created with the name of the payee's internet address when the internet-cash is received online. The payee can use the receipts from the issuer and the transaction records to cash out the deposited money from the issuer. A payer can also open an account to purchase and deposit the internet-cash. An account can be manually closed by the issuer, and it can also be automatically closed by the issuer's computer when there is no balance and no activity for a long period of time.

Bills of the internet-cash will be automatically rejected when they do not match a record in the issuer's computer. Previously deposited bills, as shown from the transaction record, will also be rejected by the computer software.

A receipt will be sent to the payer and the payee after the internet-cash is deposited. An account balance will be sent to the payee with a receipt. A rejection and warning notice will be sent to the payer and payee after the internet-cash is rejected.

Methods of Payment

The internet-cash can be paid by dragging an internet-cash icon onto a collection icon in a payee's website. When the collection icon is highlighted by overlapping the cash icon and the left mouse button is released, the internet-cash is sent to the payee and is then automatically forwarded to the internet-cash issuer via a telecommunication network. When the internet-cash code(s) from the payer matches for the first time its record existing in the issuer's computer, the issuer's computer will deposit the cash in an account named after the payee's email address, and then will send a receipt to the payee and the payer. A payee can also preset its internet-cash software to automatically tell an issuer's computer to reissue a new internet-cash to the payee instead of depositing it.

The internet-cash can also be paid by email when a payee's email is integrated to the internet-cash software so that the internet-cash received by the payee can automatically be sent to the issuer.

When the internet-cash sent by a payer is rejected, a rejection notice and warning message will be sent to the payer and the payee.

Once the internet-cash is paid, it will disappear from the payer's computer.

Methods of Issuing and Purchasing Internet-Cash

Payers can go to an issuer's office or an ATM machine to purchase the internet-cash, and store it in a computer disk.

The internet-cash can also be purchased online from an issuer's website and paid with a credit card or ATM card. Online purchase of the internet-cash can also be integrated to online banking, such as making an account of the internet-cash and transferring money to it from other accounts.

Security of Internet-Cash

Since the internet-cash comprises codes, it can be copied. Therefore, each cash code can only be used once. Once it is cashed out from or deposited to its issuer's computer, it can not be accepted by the issuer's computer again. Whoever uses it first will be valid just like in the case of conventional cash.

In addition to onetime use, other security measures can be taken: keep the internet cash in a secure place; an issuer's computer automatically makes warning to issuer's employees, a payer and a payee when the same internet-cash is used more than once or other invalid internet-cash is used; limit total internet-cash value per use from each payer site.

Since the internet-cash according to the present invention will most likely be used for small transactions such as an internet pay-per-view, the risk for consumers are very small with high convenience. The risk is also low for issuers since a mandatory cash limit per use from each payer site will be cost prohibitive for any counterfeit attempt.

Method of Covering Cost of Internet-Cash

Fee will be charged to payees by issuers since payees are usually businesses dealing with large amount of transactions.

I claim:

1. An internet-cash system for payments among computers through a telecommunication network, a bill of the internet-cash to be paid appearing as an icon on a computer screen, the internet-cash system comprising codes manageable by a computer.

2. The system of claim 1, wherein each one of the codes is for only one bill of the internet-cash.

3. The system of claim 2, wherein each one of the codes comprises the following information set by an issuer:
a) the issuer's online contact information selected from the group consisting of an email address and a phone number;
b) a value of the bill;
c) an identification portion of the code to be different than any other codes of the internet-cash issued.

4. The system of claim 3, wherein each one of the codes comprises a user's email address.

5. An internet-cash payment system comprises:
a) the internet-cash for online payment;
c) at least one computer with a software for a payer to use for a payment of the internet-cash;
d) at least one payee's computer with a software to receive a payment of the internet-cash;
e) at least one issuer's computer with a software for issuing, identifying and depositing the internet-cash;
f) a telecommunication network connecting together the payer's computer, the issuer's computer and the payee's computer;
whereby the internet-cash purchased can be sent by the payer's computer to the issuer's computer via the payee's computer to deposit the internet-cash to the payee's account in the issuer's computer.

6. The system of claim 5, wherein the internet-cash comprises codes which are manageable by a computer and transferable through a telecommunication network.

7. The system of claim 6, wherein each one of the codes is only for one bill of the internet-cash, which is one-code bill.

8. The system of claim 7, wherein each one of the codes comprises information set by an issue:
a) the issuer's online contact information selected from the group consisting of an email address and a phone number;
b) a value of the bill;
c) an identification portion of the code to be different than any other codes of the internet-cash issued.

9. The system of claim 8, wherein each one of the codes comprises a user's email address.

10. The system of claim 7, wherein a bill of the internet-cash can comprise more than one of the one-code bills, which is a multi-code bill with a total value equivalent to the sum of all the one-code bills in it.

11. The system of claim 5, wherein the computer software on a payee's computer has automatic online functions including:
a) receiving the internet-cash;
b) forwarding the internet-cash received from a payer to its issuer's computer to deposit the cash in the payee's account;
c) recording transactions;
d) keeping receipts and notices from the issuer.

12. The system of claim 11, wherein the automatic online functions further including:
a) sending a receipt to the payer right after receiving a confirmation from the issuer;
b) forwarding to the payer a rejection notice from the issuer;

13. The system of claim 11, wherein the functions of receiving and forwarding the internet-cash is provided by a collection icon on the payee's website.

14. The system of claim 5, wherein the computer software on an issuer's computer has automatic online functions including:
a) issuing new bills of the internet-cash;
b) receiving the internet-cash;
c) recording transactions, issued bills and deposited bills;
d) accepting and depositing the internet-cash received when it matches its record in the issuer's computer for the first time;
e) rejecting the internet-cash received when it is not matched, or not matched for the first time with a record in the issuer's computer.

15. The system of claim 14, wherein the automatic online functions further including:
a) creating an account;
b) closing an account;
c) sending a receipt to a payee and a payer;
d) sending a rejection notice to a payee and a payer;
e) sending a warning message to a payer and a payee when an invalid bill of the internet-cash is used.

16. The system of claim 5, wherein the computer software on a payer's computer has functions including:
a) adjusting an amount of the internet-cash for a payment;
b) paying the internet-cash to a payee;
c) showing a balance of the internet-cash.

17. The system of claim 16, wherein the functions further including:
a) providing at least one icon of the internet-cash to be paid on a computer screen;
b) providing an icon of the software on a computer screen.
c) selecting sizes and issuers of bills of the internet-cash;
d) recording transactions;
e) keeping receipts;

18. The system of claim 16, wherein the function of paying the internet-cash to a payee is done by dropping the internet-cash icon to an collection icon on a payee's website

19. A method of paying an internet-cash online, each bill of the internet-cash comprising at least one code, each code including an identification portion of the code to be different from any other codes issued, a value of the bill, and an issuer's online contact information selected from the group consisting of an email address and a phone number, the method comprising the following steps:
a) a payer purchasing the internet-cash from an issuer;
b) the payer sending the internet-cash to a payee's computer;
c) the payee's computer automatically forwarding the internet-cash to its issuer's computer;
d) the issuer's computer automatically depositing the received internet-cash in the payee's account when the internet-cash matches for the first time its record in the issuer's computer;
e) the issuer's computer automatically reject the internet-cash received when the internet-cash does not match a record in the issuer's computer for the first time.

20. The method of the claim 19 further comprising the steps of:
a) the issuer's computer sending a receipt to the payer and the payee;
b) the issuer's computer sending a rejection and warning letter to the payer and the payee.
